(19) United States
(12) Patent Application Publication
(10) Pub. No.: US 2009/0254581 A1
(43) Pub. Date: Oct. 8, 2009

(54) Knowledge discovery system capable of custom configuration by multiple users

(76) Inventors: Alan R. Chappell, Seattle, WA (US); Christian Posse, Seattle, WA (US); Judith R. McCuaig, Guelph (CA); Alan R. Willse, Des Moines, IA (US); Alexander A. Donaldson, Seattle, WA (US); Stephen C. Tratz, Boise, ID (US); David A. Thurman, Kenmore, WA (US); Stuart J. Rose, Richland, WA (US); Gary R. Danielson, Kennewick, WA (US)

Correspondence Address: Douglas E. McKinley, Jr., PO Box 202, Richland, WA, 99352, US

(21) Appl. No.: 12/080,753

(22) Filed: Apr. 4, 2008

(51) Int. Cl. G06F 7/00; G06F 17/30

(52) U.S. Cl. 707/102; 707/E17.002

(57) ABSTRACT

An automated method for allowing multiple users to independently analyze a corpus of digital information having discrete elements by providing two or more users access to one or more initial training source of digital information, allowing the users to each define a set of categories, automatically generating a group of digital features associated with at least two of the discrete elements, automatically associating a subset of the discrete elements with at least one of the categories, and automatically determining at least one combination of features and transformed features that identifies at least one of the categories. The automated method allows said two or more users to have the capability to perform the step of defining a set of categories, such that the automated steps of generating a group of digital features, associating a subset of said discrete elements, and determining at least one combination of features and transformed features is in whole or in part determined by the manual input to the automated method.

The invention was made with Government support under Contract DE-AC0676RLO 1830, awarded by the U.S. Department of Energy. The Government has certain rights in the invention.

### TECHNICAL FIELD

This invention relates to computer based knowledge discovery systems. More specifically, the present invention relates to computer based knowledge discovery systems that allow multiple users to each use custom parameters to configure the system.

### BACKGROUND OF THE INVENTION

Knowledge discovery is a concept of the field of computer science that describes the process of automatically searching large volumes of data for patterns that can be considered knowledge about the data. It is often described as deriving knowledge from the input data. This complex topic can be categorized according to 1) what kind of data is searched; and 2) in what form is the result of the search represented.

The most well-known branch of knowledge discovery is data mining, also known as Knowledge Discovery in Databases (KDD). Just as many other forms of knowledge discovery, data mining creates abstractions of the input data. The knowledge obtained through this process may become additional data that can be used for further usage and discovery.

Data mining processes and techniques are used by business intelligence organizations, financial analysts, law enforcement organizations, investigators, and in the sciences to extract relevant information from the enormous data sets generated by modern experimental and observational methods. Data mining has been described as “the nontrivial extraction of implicit, previously unknown, and potentially useful information from data” and “the science of extracting useful information from large data sets or databases.”

The explosion of data contained in computer readable forms has greatly increased the value of data mining techniques. The vast majority of information available for such synthesis, 95% according to estimates by the National Institute for Science and Technology (NIST), is in the form of written natural language. The traditional method of analyzing and characterizing information in the form of written natural language is to simply read it. Even the subset of computer readable data that is not in written natural language is often “read” or reviewed by people using computer mediated tools. However, this approach is increasingly unsatisfactory as the sheer volume of information outpaces the time available for manual review.

Among the methodologies for automating the analysis and characterization of digital information are vector based systems using first order statistics. These systems attempt to define relationships between documents based upon simple characteristics of the documents, such as word counts.

The simplest of these methodologies is a simple search wherein a word or a word form is entered into the computer as a query and the computer compares the query to words contained in the documents in the database to determine if matches exist. If there are matches, the computer then returns a list of those documents within the database which contain a word or word form which matches the query.

This simple search methodology may be expanded by the addition of other Boolean operators into the query. For example, the computer may be asked to search for documents which contain both a first query and a second query, or a second query within a predetermined number of words from the first query, or for documents containing a query which consist of a series of terms, of for documents which contain a particular query but not another query. Whatever the particular parameters, the computer searches the database for documents which fit the required parameters, and those documents are then returned to the user.

Among the drawbacks of such schemes is the possibility that in a large database, even a very specific query may match a number of documents that is too large to be effectively reviewed by the user. Additionally, given any particular query, there exists the possibility that documents which would be relevant to the user may be overlooked because the documents do not contain the specific query tern identified by the user; in other words, these systems often ignore word to word relationships, and thus require exacting queries to insure meaningful search results. Because these systems tend to require exacting queries, these methods suffer from the drawback that the user must have some concept of the contents of the documents in order to draft a query which will generate the desired results. This presents the users of such systems with a fundamental paradox: In order to become familiar with a database, the user must ask the right questions or enter relevant queries; however, to ask the right questions or enter relevant queries, the user must already be familiar with the database.

To overcome these and other drawbacks, a number of methods have arisen which are intended to compare the contents of documents in an electronic database and thereby determine relationships between the documents. In this manner, documents that address similar subject matter but do not share common key words may be linked, and queries to the database are able to generate resulting relevant documents without requiring exacting specificity in the query parameters. For example, vector based systems using higher order statistics may be characterized by the generation of vectors which can be used to compare documents. By measuring conditional probabilities between and among words contained within the database, different terms may be linked together.

Further systems have been developed that utilize algorithms to discern words which provide insight into the meaning of the documents which contain them. One approach to this problem is to utilize neural networks or other methods to capture the higher order statistics required to compress the vector space. Another approach is described in U.S. Pat. No. 6,772,170 “System and method for interpreting document contents.”

The U.S. Pat. No. 6,772,170 patent describes a technique whereby a database is automatically queried to find the topics of contents of documents in the database. Briefly, a sequence of word filters are used to eliminate terms in the database which do not discriminate document content, such as “the” “and” “in” and “a”. This filtering resulting in a filtered word set and a topic word set whose members are highly predictive of content. These two word sets are then formed into a two dimensional matrix with matrix entries calculated as the conditional probability that a document will contain a word in a row given that it contains the word in a column. The matrix representation allows the resultant vectors to be utilized to interpret document contents.

While often effective at thematic analysis of a document set, such methods sometime fail to communicate meaningful results to individual users. The interpretation of content is based on mathematically identified differences in tern co-occurrence and such differences may not correspond to the knowledge goals of the user.

Alternatively, classification-based systems have focused on extracting prescribed knowledge from document sets. Using such approaches, the system is designed to interpret document contents by placing documents in one of more groupings where the groupings are associated with defined knowledge goals. These interpretations are typically based on rule sets that match specific word combinations to knowledge goals or on mathematical algorithms that characterize a given group of example documents that are associated a priori with the knowledge goals and subsequently apply that characterization to new documents.

While these and other information discovery systems often allow multiple users to access the system and the databases used by these systems, one drawback of these and other similar approaches is that the results generated by the system typically are influenced by the initial parameters given to the system. Accordingly, a specific user of these systems often may not enjoy the benefits that would be attained were the system configured for that specific user. Thus there exists a need for knowledge discovery systems that can allow multiple users access to the system and the database associated with the system, while allowing each of these users the ability to configure the system in a manner appropriate or desired by that user.

### SUMMARY OF THE INVENTION

The present invention is an automated computer system and method for allowing multiple users to independently analyze a corpus of digital information. More specifically, the present invention is an automated computer system and method for allowing each of multiple users to independently analyze a corpus of digital information in a manner that is custom tailored to the desired results sought by each individual user.

As used herein, “digital information” means any form of data that can be stored in a binary form, and would include any information stored in any optical or electromagnetic memory or storage system used by any computer system, including without limitation, hard drives, a floppy drives, optical drives, RAM, DRAM, cds, dvds, or tapes. Typically, while not meant to be limiting, the “digital information” that is manipulated by the present invention are digital representations of natural language based documents.

The digital information analyzed by the present invention is characterized as having discrete elements. By way of example, but not meant to be limiting, these discrete elements could include individual documents, such as email messages, word processing files, web pages, or other logical groupings of digital information. By way of further example, but still not meant to be limiting, these discrete elements could include subsets of the forging, including without limitation, meta data, and/or sub-elements of individual documents, such as individual fields in the header information of email messages, meta tags of web pages, or tiles of word processing files, or any other logical grouping of digital information. The discrete elements of the present invention may further be normalized, using mathematical techniques well know to those having ordinary skill in the art. Each of the discrete elements can be characterized by a set of digital features. Features are distinct elements of the digital information that can be computationally detected, and thus, functions of their presence may be used as descriptors of the original discrete elements. Features may also include transformations and combinations of other features. A digital feature is any subset of the digital element or transformation of the digital element. By way of example, but not meant to be limiting, these features could include words or word groupings in a text document or shapes in a digital image identified by a transformational algorithm.

The system and method of the present invention provides two or more users to access to one or more initial training sources of digital information. Each user is then able to configure the system of the present invention in a manner that is most advantageous to that specific user's needs. The user begins this process by defining a set of categories into which the digital information may be sorted. The method and system of the present invention then automatically generates a group of digital features associated with at least two of the discrete elements of the digital information. The system and method of the present invention then associates a subset of the discrete elements of the initial training source with at least one of the categories selected by the user. The system and method then determines at least one combination of features and transformed features that identifies at least one of the categories that was selected by the user.

In this manner, the system and method of the present invention allows two or more users to each have the capability to perform the step of defining a set of categories, so that the automated steps of generating a group of digital features, associating a subset of the discrete elements, and determining at least one combination of features and transformed features, in whole or in part, are determined by the manual input of the user to the automated method. In this manner, each user is provided the capability to configure the system and method of the present invention in a manner determined by the specific categories selected by the user.

Once a subset of the discrete elements of the initial training source are associated with at least one of the categories selected by the user, the system and method of the present invention then allows additional discrete elements of digital information, inside and/or outside of the initial training set, to be automatically categorized in the manner desired by the user. These additional discrete elements of digital information inside and/or outside of the initial training set may comprise one or more of the grouping(s) of digital elements, additional digital information added to the groupings(s), or combinations thereof.

While not meant to be limiting, the system and method of the present invention is preferably configured to automatically inspect each additional discrete element of the digital information to determine the features. By comparing the features of the discrete elements of the additional digital information with the combination of features and transformed features that identified at least one of the categories, the system and method of the present invention automatically associates the discrete elements of that digital information with zero, one, or more of the categories, based upon the comparison.

The discrete elements of digital information to be automatically categorized may be selected from the initial training source of digital information, at least one new source of digital information, or combinations thereof. The present invention then allows the user to extract meta data selected from the category defined by the user, meta data association with a category, features associated with a category, or a discrete element based upon the identification of features and categorization of that discrete element.

In one particular configuration of the present invention, but not meant to be limiting, the discrete elements are provided to the present invention by automatically inputting the discrete elements from sources available through a network, such as a private local area network (LAN), an enterprise's wide area network (WAN), or a public network, such as the internet.

Preferably, but not meant to be limiting, the present invention is configured to provide a graphical user interface showing the categories as multi-dimensional features. The system may be further configured to allow the user to define relationships between various categories and arrange multi-dimensional features of discrete elements, whether shown in a graphical user interface or otherwise, according to those user-defined relationships.

Alternatively, the present invention may be configured to automatically detect relationships between categories using vectors created from the discrete elements and arranging the multi-dimensional features, whether shown in a graphical user interface or otherwise, according to relationships between the vectors.

In one embodiment of the present invention, while not meant to be limiting, the graphical user interface can show a blending of multi-dimensional features between multi-dimensional features arranged according to user defined relationships between categories, and multi-dimensional features arranged according to relationships between vectors representing the discrete elements within the categories.

### BRIEF DESCRIPTION OF THE DRAWINGS

The following detailed description of the embodiments of the invention will be more readily understood when taken in conjunction with the following drawings, wherein:

FIG. 1 provides an illustration of the steps of a preferred embodiment of the method of the present invention.

FIG. 2 provides an illustration of the Element Preprocessing step of a preferred embodiment of the method of the present invention.

FIG. 3 provides an illustration of the Signature Generation step of a preferred embodiment of the method of the present invention.

FIG. 4 provides an illustration of the Classification step of a preferred embodiment of the method of the present invention.

FIG. 5 provides an illustration of the Analysis step of a preferred embodiment of the method of the present invention.

FIG. 6 is a depiction of the graphical user interface of a preferred embodiment of the present invention showing an environment supporting folder-based navigation to documents placed in User specified category groupings.

FIG. 7 is a depiction of the graphical user interface of a preferred embodiment of the present invention showing contents of document with supporting information for the given classifications.

FIG. 8 is a depiction of the graphical user interface of a preferred embodiment of the present invention showing the categories of FIG. 6 as multi-dimensional features. The displayed positions of the categories enables the User to visualize the relationships between categories.

FIG. 9 is a depiction of the graphical user interface of a preferred embodiment of the present invention showing a range of blending between features resulting in the user interface focusing on user defined relationships.

FIG. 10 is a depiction of the graphical user interface of a preferred embodiment of the present invention showing a range of blending between features resulting in the user interface focusing on relationships inherent in the news stories.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

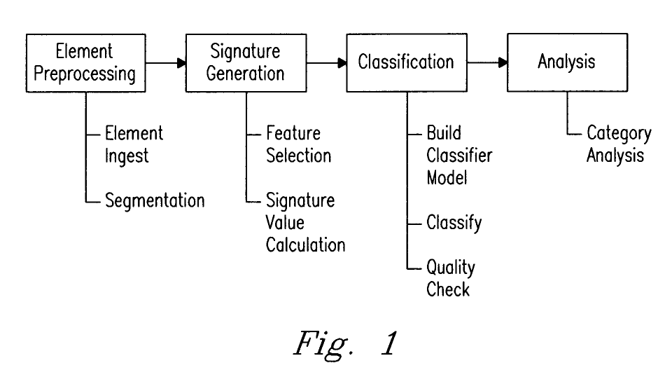

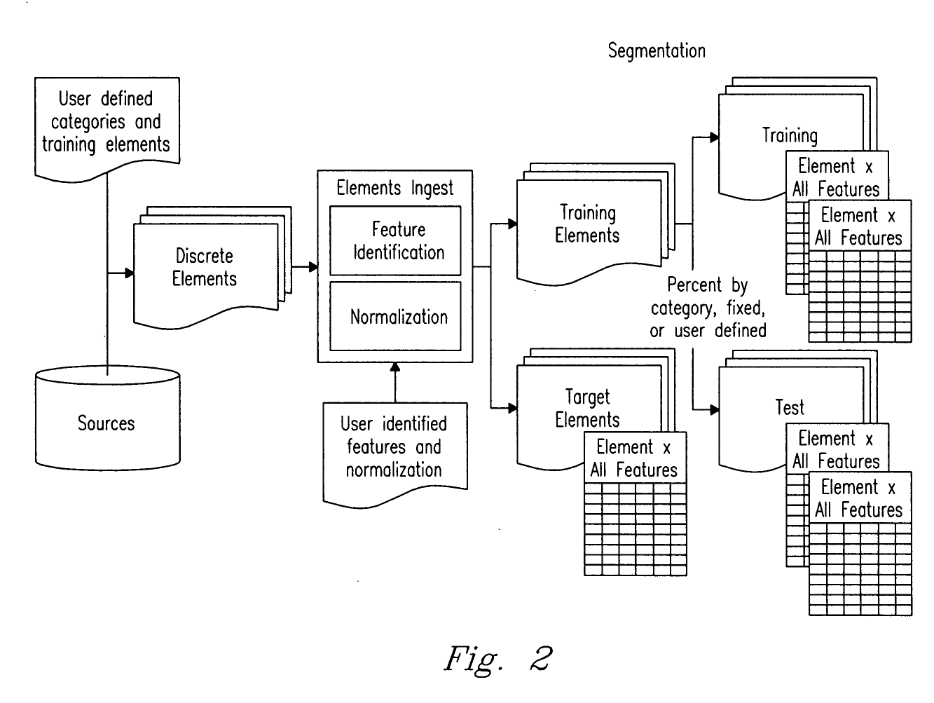

FIG. 1 provides an illustration of the steps of a preferred embodiment of the method of the present invention. FIGS. 2, 3, 4 and 5 provide a more detailed illustration of each of the individual steps shown in FIG. 1.

As shown in FIG. 1, the method of the present invention consists of four broad steps, element preprocessing, signature generation, classification, and analysis. The element preprocessing step is shown in greater detail in FIG. 2. The element preprocessing step generates a computational representation of the discrete elements of digital information by Element Ingest and Segmentation.

In the Element Ingest step is composed by two sub-steps, Feature Identification and Normalization. In the Feature Identification sub-step, potential features from the original discrete elements of digital information are enumerated. Features are distinct elements of the digital information that can be computationally detected, and thus, functions of their presence may be used as descriptors of the original discrete elements. Features may also include transformations and combinations of other features. In the Normalization sub-step, combinations of algorithmic and/or pattern based normalization steps are applied to enhance the comparability between different discrete elements in the sources.

In the Segmentation step, a segment of the training elements for use in testing is selected. This segment is a percentage and the same percent of the training documents in each category are selected. A fixed percent is chosen, or a percent identified by the user.

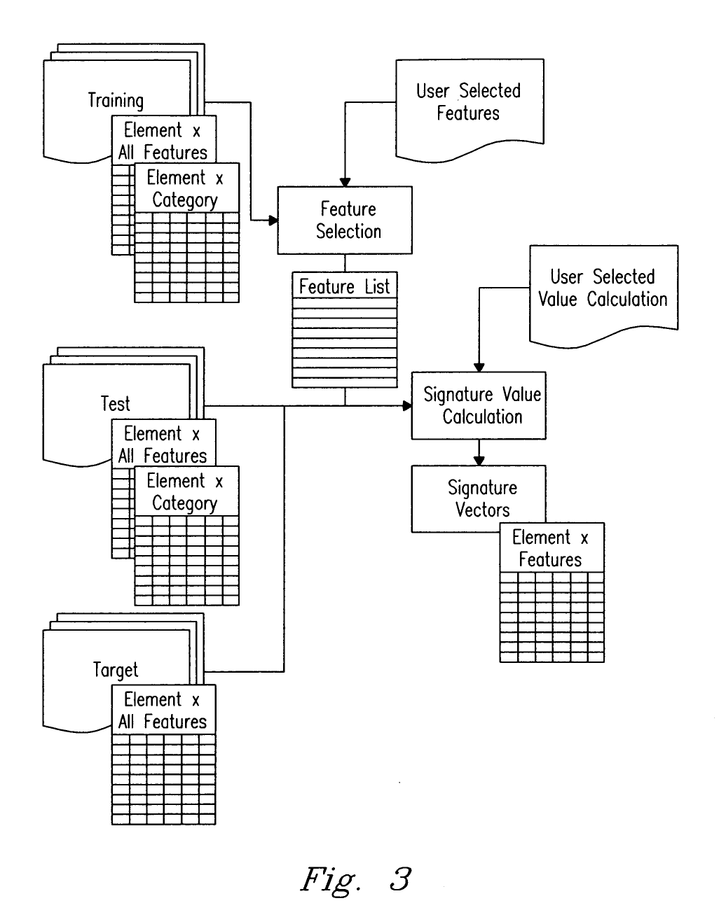

As shown in FIG. 1, the next step is Signature Generation, which consists of Feature selection and Signature value calculation. A more detailed flow diagram of this step is shown in FIG. 3.

Feature selection is performed by selecting a set of features, combinations of features, or transformations of features, from the possible features identified at ingest. Features are selected for use as terms in the descriptive vector (or components in the element signature) across all discrete elements. Feature sets are associated with one or more categories.

Signature value calculation is performed by calculating a value associated with each of the selected features for each discrete element by providing the values for each component of the signature.

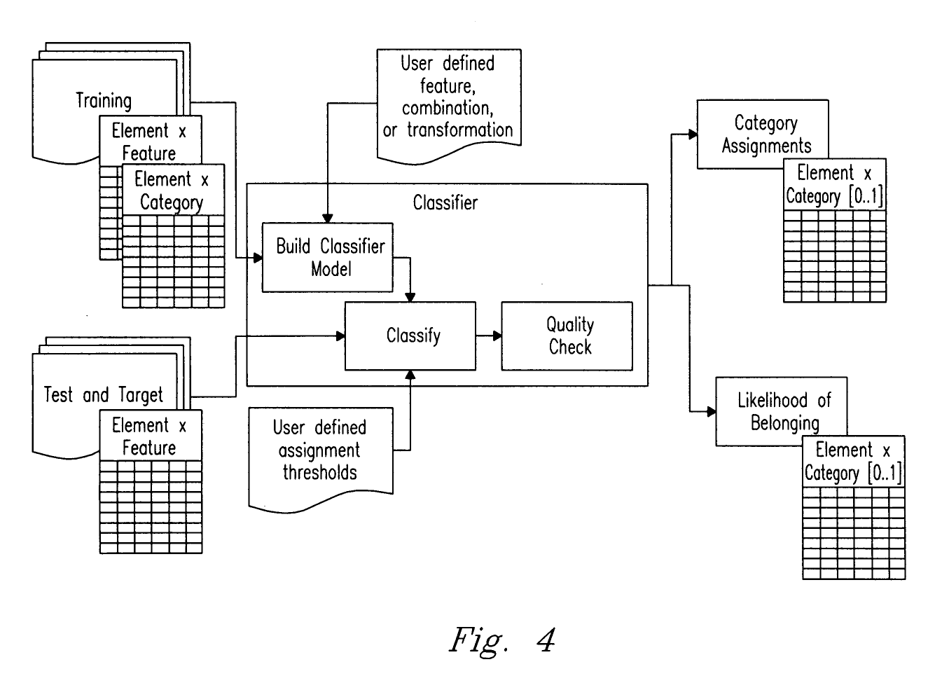

As shown in FIG. 1, the next step is Classification, which consists of building the classifier model, classifying the discrete elements, and performing a quality check. A more detailed flow diagram of this step is shown in FIG. 4.

To build the Classifier Model, the system uses the signature vectors of the discrete elements identified for training and the categories the user associated with those discrete elements to create a computational representation of the transformations necessary to map the training signatures into one or more of the given categories.

To classify the discrete elements, the system applies the classifier model to the signature of a discrete element yielding an assignment to zero or more categories and a likelihood of belonging in each category. The Quality check uses the likelihood of belonging for the test documents to determine an apparent threshold of assignment. The quality of the classifier model is then assessed using the value of the apparent threshold. classifier performance on training and test elements, and the number of training examples.

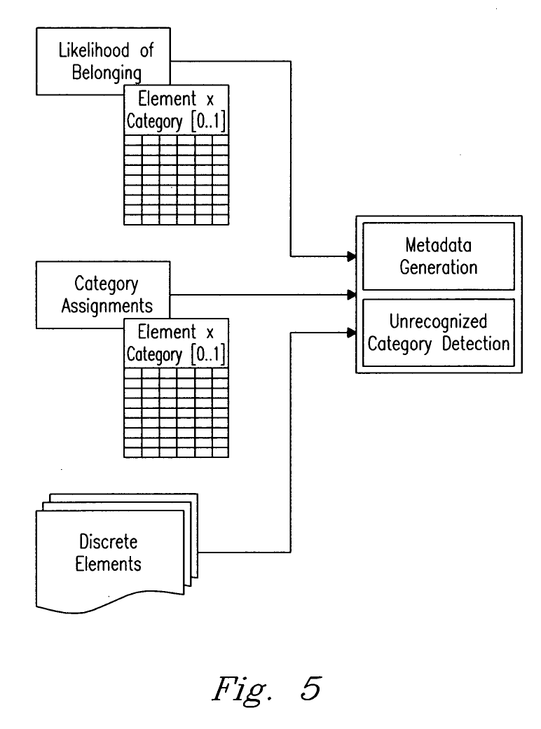

As shown in FIG. 1, the final step is Analysis, which consists solely of Category analysis. As will be recognized by those having ordinary skill in the art, the Analysis step is optional. A more detailed flow diagram of this step is shown in FIG. 5. In this step, the system performs of Metadata generation and Unrecognized category detection. Metadata generation creates content-based metadata for each element including the categories to which the document was assigned and descriptive or extracted evidence for that assignment. The metadata is structured to enumerate the categories identified. In Unrecognized category detection, digital elements that are not assigned to any categories are identified, and one or more new categories may be added to group all such elements.

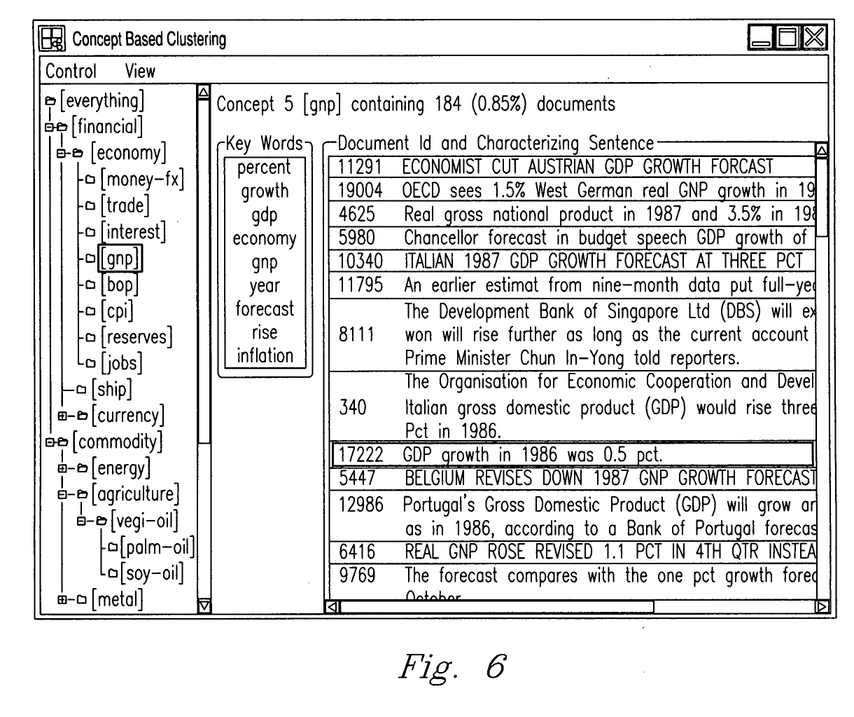

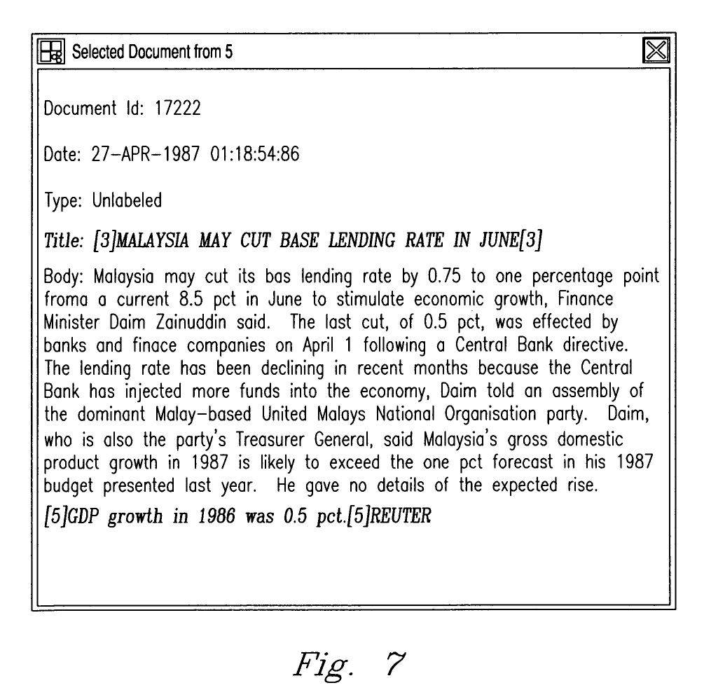

FIGS. 6-10 show the user interface provided by a preferred embodiment of the present invention reduced to practice, and operated using digital information available to a financial and commodities analyst. As shown in FIG. 6, a user (“User 1”) has configured the system so that the categories “Financial” and “Commodities” are provided, and then decomposed in further subcategories. The financial category breaks down into currency, shipping, and economy categories, and the subcategories can then break down further. FIG. 6 shows a snapshot of a folder-based interface assisting User 1 in reviewing the information available about these categories. Using the present invention, the system was trained using stories in each category folder to build a classifier model. Then when new stories become available, the system classifies the stories and places them in each of the category folders corresponding to categories identified in the story. Here in FIG. 6, User 1 has selected the category “gnp” and sees a list of news stories that discuss the gross national product. Further, User 1 has selected one particular document in this category, the highlighted 17222. Since that document contains two categories from User 1's organization, these two categories, “gnp” and “interest” are highlighted in colors in the category hierarchy. Selecting that newswire story also brings up a view of the content as depicted in FIG. 7.

Another user (“User 2”) may focus on international relationships. Therefore, User 2 may have an organization based on region and country of origin of the message. Hence User 2 may have a hierarchy that includes such regions as North America, South America, Europe, and Middle East, each of which is further decomposed into countries. Here the classifier does more that a simple keyword lookup. For example, the China classifier will learn to look for combinations of words such as China, Sino, Beijing, and many others that indicate the presence of the “China” concept (category). For another project, User 2 may have another organization focused on world conflicts, and so has folders in this separate organization for “Iran-Iraq war”, “Soviet-Afghanistan conflict”, and many others.

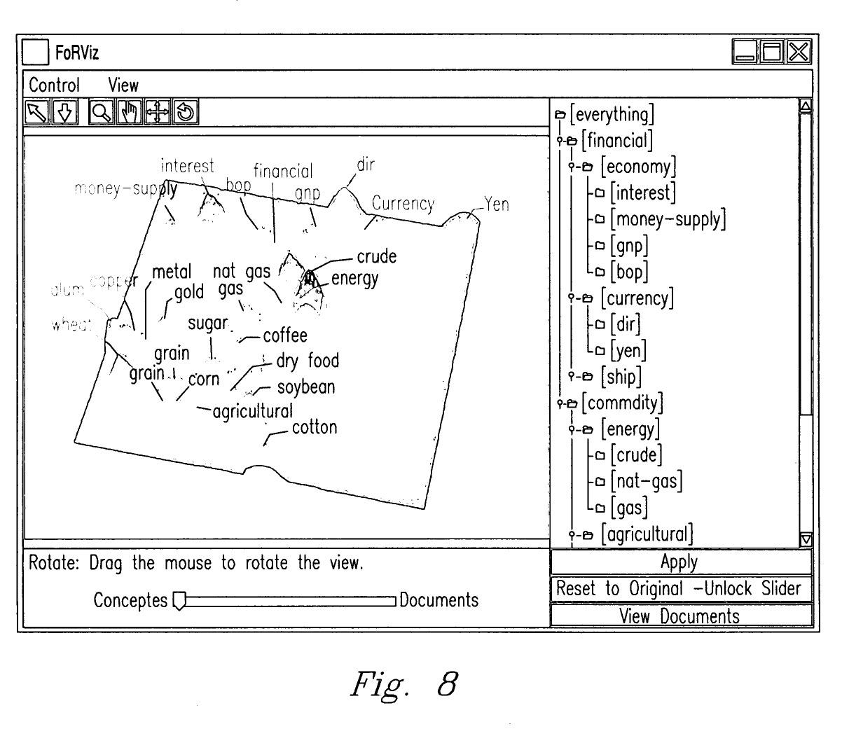

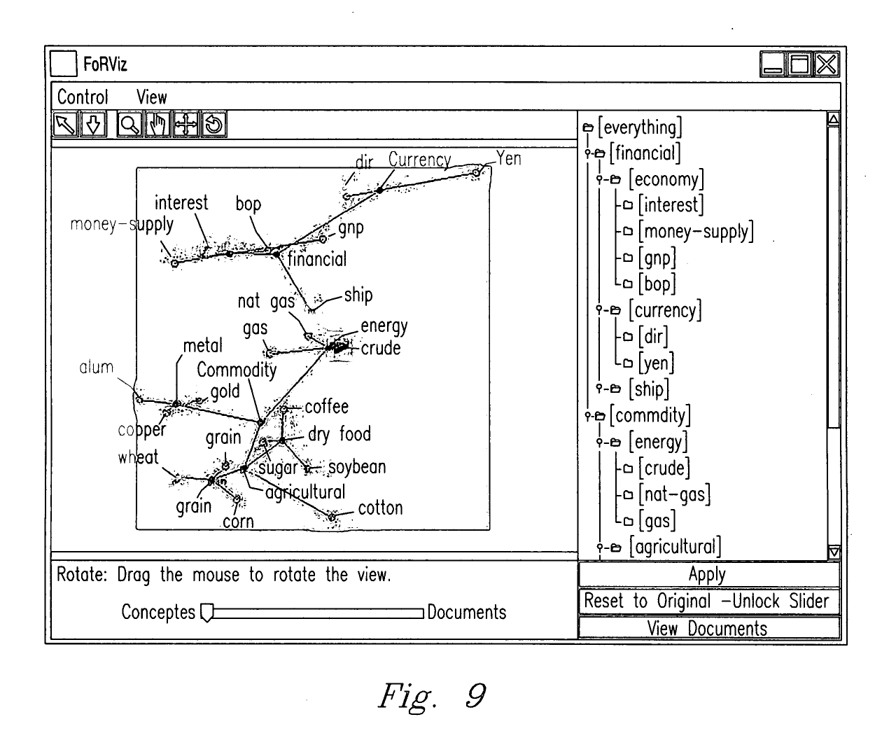

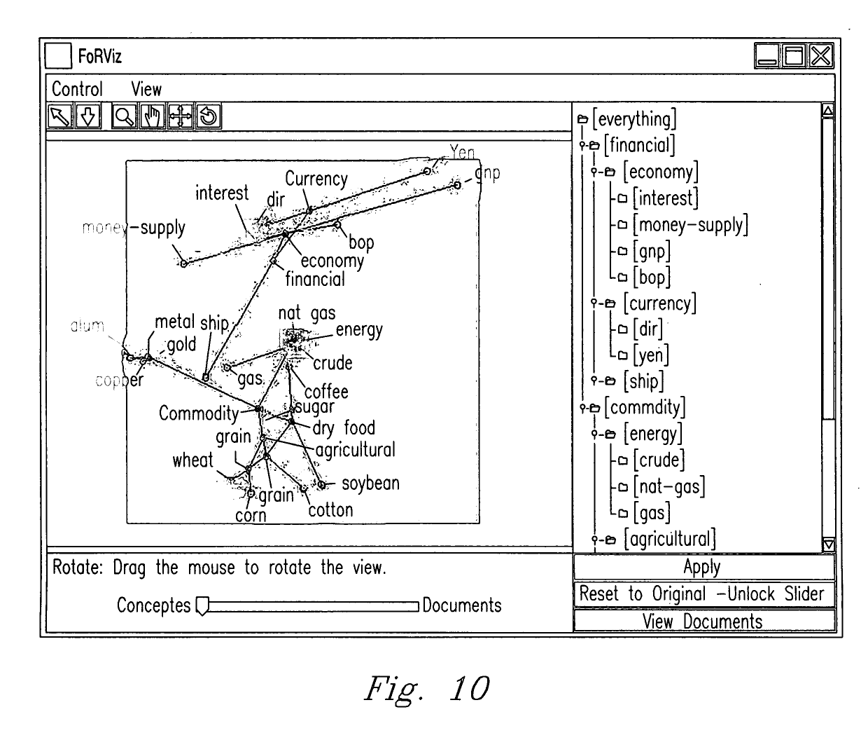

FIG. 8 depicts a graphical user interface showing the categories of User 1 above as multi-dimensional features. The displayed positions of the categories enable User 1 to visualize the relationships between categories. FIGS. 9 and 10 depict a range of blending between features resulting in the UI focusing on relationships defined by User 1, and shown in FIG. 9, or relationships inherent in the news stories as shown in FIG. 10.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Finally, all publications, patents, and patent applications cited in this specification are herein incorporated by reference to the extent not inconsistent with the present disclosure as if each were specifically and individually indicated to be incorporated by reference and set forth in its entirety herein.

The invention claimed is:

1) An automated method for allowing multiple users to independently analyze a corpus of digital information having discrete elements comprising the steps of:
a. providing two or more users access to one or more initial training source of digital information,
b. allowing two or more users to each define a set of categories
c. automatically generating a group of digital features associated with at least two of the discrete elements of said digital information
d. automatically associating a subset of said discrete elements of said initial training source with at least one of said categories
e. automatically determining at least one combination of features and transformed features that identifies at least one of said categories
f. wherein the automated method allows said two or more users to have the capability to perform the step of defining a set of categories, such that the automated steps of generating a group of digital features, associating a subset of said discrete elements, and determining at least one combination of features and transformed features, is in whole or in part determined by the manual input to the automated method.

2) The method of claim 1 further comprising the steps of:
a. providing discrete elements of digital information
b. determining features from discrete elements of digital information
c. comparing the features of the discrete elements of digital information with the combination of features and transformed features that identifies at least one of said categories, and
d. based upon said comparison, associating said discrete elements of digital information with zero, one, or more of said categories.

3) The method of claim 2 wherein the discrete elements of digital infonnation are selected from the initial training source of digital information, at least one new source of digital information, or combinations thereof.

4) The method of claim 3 comprising the further steps of
a. having at least one user manually re-associate at least one discrete element of digital information with at least one category
b. defining a set of categories
c. generating a group of digital features associated with at least two of the discrete elements of said digital information
d. associating a subset of said discrete elements with at least one of said categories
e. determining at least one combination of features and transformed features that identifies at least one of said categories
f. wherein the automated method allows said two or more users to have the capability to perform at least one of the steps of defining a set of categories, generating a group of digital features, associating a subset of said discrete elements, and determining at least one combination of features and transformed features, in whole or in part, as a manual input to the automated method.

5) An automated method for generating content based meta data from a corpus of digital information having discrete elements comprising the steps of:
a. providing an initial training source of digital information,
b. defining a set of categories
c. generating a group of digital features associated with at least two of the discrete elements of said initial training source of digital information
d. associating a subset of said discrete elements of said initial training source with at least one of said categories
e. determining at least one combination of features and transformed features that identifies at least one of said categories, wherein a user has performed at least one of the steps of defining a set of categories, generating a group of digital features, associating a subset of said discrete elements, and determining at least one combination of features and transformed features, in whole or in part, as a manual input,
f. providing additional discrete elements of digital information
g. determining features from discrete elements of digital information
h. comparing the features of the discrete elements of digital information with the combination of features and transformed features that identifies at least one of said categories, and
i. categorizing said discrete elements of digital information according to said comparison,
j. extracting metadata from a discrete element from the training or additional elements groups consisting of the category, association with a category, features associated with a category, based upon the identification of features and categorization of discrete elements.

6) The method of claim 1 wherein the training data is a file of email messages.

7) The method of claim 2 wherein the discrete elements are individual email messages.

8) The method of claim 2 wherein the step of providing said discrete elements is performed by automatically inputting said discrete elements from sources available through a network.

9) The method of 8 where the network is the internet.

10) The method of claim 2 further comprising the step of providing a graphical user interface showing the categories as multi-dimensional features.

11) The method of claim 10 further comprising the step of allowing the user to define relationships between said categories and arrange said multi-dimensional features according to said user defined relationships.

12) The method of claim 10 further comprising the step of automatically defining relationships between said categories using vectors created from the discrete elements and arranging said multi-dimensional features according to relationships between said vectors.

13) The method of claim 10 wherein said graphical user interface can show a blending of multi-dimensional features between
a. said multi-dimensional features arranged according to user defined relationships between categories, and
b. said multi-dimensional features arranged according to relationships between vectors representing said discrete elements within said categories.

14) The method of claim 1, comprising the further step of normalizing the discrete elements.

15) The method of claim 2, comprising the further step of normalizing the discrete elements.

16) A computer system configured to allow multiple users to independently analyze a corpus of digital information having discrete elements, said computer system configured to perform the steps comprising:
a. providing two or more users access to one or more initial training source of digital information,
b. accepting input from two or more users each defining a set of categories
c. automatically generating a group of digital features associated with at least two of the discrete elements of said digital information
d. automatically associating a subset of said discrete elements of said initial training source with at least one of said categories
e. automatically determining at least one combination of features and transformed features that identifies at least one of said categories
f. wherein the computer system accepts input from said two or more users to perform the step of defining a set of categories., such that the automated steps of generating a group of digital features, associating a subset of said discrete elements, and determining at least one combination of features and transformed features.

17) The computer system of claim 16 wherein said computer system is further configured to perform the steps comprising:
a. accepting as input discrete elements of digital information
b. determining features from discrete elements of digital information
c. comparing the features of the discrete elements of digital information with the combination of features and transformed features that identifies at least one of said categories, and
d. based upon said comparison, associating said discrete elements of digital information with zero, one, or more of said categories.

18) The computer system of claim 17 wherein the discrete elements of digital information are selected from the initial training source of digital information, at least one new source of digital information, or combinations thereof.

19) The computer system of claim 18 further configured to perform the steps comprising
a. accepting input from at least one user manually re-associating at least one discrete element of digital information with at least one category
b. defining a set of categories
c. generating a group of digital features associated with at least two of the discrete elements of said digital information
d. associating a subset of said discrete elements with at least one of said categories
e. determining at least one combination of features and transformed features that identifies at least one of said categories
f. wherein the computer system accepts input from said two or more users to perform at least one of the steps of defining a set of categories, generating a group of digital features, associating a subset of said discrete elements, and determining at least one combination of features and transformed features.

20) A computer system configured to automatically generate content based meta data from a corpus of digital information having discrete elements by performing the steps comprising:
a. accepting as input an initial training source of digital information,
b. defining a set of categories
c. generating a group of digital features associated with at least two of the discrete elements of said initial training source of digital information
d. associating a subset of said discrete elements of said initial training source with at least one of said categories
e. determining at least one combination of features and transformed features that identifies at least one of said categories, wherein the computer is configured to accept as input at least one of the steps of defining a set of categories, generating a group of digital features, associating a subset of said discrete elements, and determining at least one combination of features and transformed features,
f. providing additional discrete elements of digital information
g. determining features from discrete elements of digital information
h. comparing the features of the discrete elements of digital information with the combination of features and transformed features that identifies at least one of said categories, and
i. categorizing said discrete elements of digital information according to said comparison,
j. extracting metadata from a discrete element from the training or additional elements groups consisting of the category, association with a category, features associated with a category, based upon the identification of features and categorization of discrete elements.

21) The computer system of claim 16 wherein the training data is a file of email messages.

22) The computer system of claim 17 wherein the discrete elements are individual email messages.

23) The computer system of claim 17 wherein the step of providing said discrete elements is performed by automatically inputting said discrete elements from sources available through a network.

24) The computer system of claim 23 where the network is the internet.

25) The computer system of claim 17 further configured to perform the step of providing a graphical user interface showing the categories as multi-dimensional features.

26) The computer system of claim 25 further configured to perform the step of allowing the user to define relationships between said categories and arrange said multi-dimensional features according to said user defined relationships.

27) The computer system of claim 25 further configured to perform the step of automatically defining relationships between said categories using vectors created from the discrete elements and arranging said multi-dimensional features according to relationships between said vectors.

28) The computer system of claim 25 wherein said graphical user interlace can show a blending of multi-dimensional features between
a. said multi-dimensional features arranged according to user defined relationships between categories, and
b. said multi-dimensional features arranged according to relationships between vectors representing said discrete elements within said categories.

29) The computer system of claim 16 further configured to perform the step of normalizing the discrete elements.

30) The computer system of claim 17 further configured to perform the step of normalizing the discrete elements.
